(19) United States
(12) Patent Application Publication
(10) Pub. No.: US 2012/0093696 A1
(43) Pub. Date: Apr. 19, 2012

(54) SYSTEM FOR DEGRADING AND REMOVING TOXIC SUBSTANCE BY MEANS OF THERMAL EXCITATION OF CHROMIUM OXIDE OR NICKEL OXIDE

(76) Inventors: Jin Mizuguchi, Yokohama-Shi (JP); Shigeru Suzuki, Kanagawa (JP); Ryo Iwamoto, Kanagawa (JP); Yoshiyuki Sato, Kanagawa (JP)

(21) Appl. No.: 13/131,110

(22) PCT Filed: Nov. 25, 2009
(86) PCT No.: PCT/JP2009/069880

§ 371 Date: Jan. 3, 2012

(30) Foreign Application Priority Data
Nov. 26, 2008 (JP) 2008-300774

(51) Int. Cl. B01D 53/86

(52) U.S. Cl. 422/173

(57) ABSTRACT

There is provided a system for decomposing and removing a toxic substance by introducing a gas containing the toxic substance into a reaction apparatus and causing the gas to contact with a heated oxide semiconductor, in which a porous material carrying, as the oxide semiconductor, chromium oxide or nickel oxide is placed in the reaction apparatus, chromium oxide or nickel oxide is thermally excited, and the gas is contacted with the chromium oxide or nickel oxide which is thermally excited. Thus, it is possible to provide a practically useful technique for decomposing and removing a toxic substance with high decomposition/removal efficiency.

### TECHNICAL FIELD

The present invention relates to a system for decomposing and removing a toxic substance using thermal excitation of chromium oxide (hereinafter meaning Cr₂O₃ in the present invention) or nickel oxide (hereinafter meaning NiO in the present invention).

### BACKGROUND ART

Recently, extensive discharge of volatile organic compounds (VOC) which are a cause of photochemical smog or sick house syndrome is an environmental problem, and thus, there is a need for an effective removal system. The same is true with regard to malodorous components such as ammonia and poisonous components such as hydrogen sulfide.

The present inventors have researched generation of large amounts of holes due to strong thermal excitation of an oxide semiconductor as well as a system for decomposing toxic organic substances by strong oxidizing powers of the holes, and have already provided a system for thermally exciting an oxide semiconductor to decompose and remove VOC and the like (for example, refer to Japanese Patent Application Laid-Open (JP-A) No. 2005-139440).

In the system, holes generated by thermal excitation of the oxide semiconductor deprive an organic substance of bonding electrons to form a cation radical. The radical propagates in the organic substance and induces a radical cleavage whereby fragmentation occurs. The fragmented small molecules are completely combusted in the presence of sufficient oxygen and converted into H₂O and CO₂. Basically, the decomposition reaction is a combustion reaction, and the holes are a means for fragmenting a large molecule.

### DISCLOSURE OF INVENTION

### Technical Problem

According to JP-A No. 2005-139440, among oxide semiconductors, titanium oxide is the most effective one for decomposition of VOC and the like. In fact, an anatase-type titanium oxide (ST01: ISHIHARA SANGYO KAISHA, LTD.) having a specific surface area of 300 m²/g exhibits the highest effect.

However, points that need to be improved have been observed in forging ahead with development. That is, the following has been found. The decomposition ability of VOC by titanium oxide is very high. For example, taking toluene as the VOC, when air containing toluene at a high concentration of 10,000 ppm is treated, it can be decomposed to about 200 ppm at relatively low temperatures; however, in order to reduce the concentration of toluene to the above level or less (for example, reducing the concentration of toluene to almost zero), it is necessary to bring the toluene into contact with titanium oxide under higher temperature conditions.

The present invention has been made based on the above findings, and it is an object of the invention to provide a technique for removing a toxic substance in a gas by thermal excitation of an oxide semiconductor, which is a practically useful technique for decomposing and removing a toxic substance with high decomposition/removal efficiency.

### Solution to Problem

The system for decomposing and removing a toxic substance of the present invention is a system for decomposing and removing a toxic substance of the present invention by introducing a gas containing the toxic substance into a reaction apparatus and causing the gas to contact with a heated oxide semiconductor, wherein a porous material carrying, as the oxide semiconductor, at least one of chromium oxide or nickel oxide is placed in the reaction apparatus, and the system includes thermally exciting the at least one of chromium oxide or nickel oxide, and contacting the gas containing the toxic substance with the at least one of chromium oxide or nickel oxide which is thermally excited.

Among them, the porous material is preferably a pseudo honeycomb body formed by stacking plural SUS meshes, a cordierite honeycomb or a corrugated honeycomb made of glass fiber, silica, zeolite and/or the like.

It is preferable that the porous material is immersed in a suspension containing at least one of chromium oxide particles or nickel oxide particles and nitrocellulose and heat-treated at 180° C. or higher to carry at least one of the chromium oxide particles or nickel oxide particles.

### ADVANTAGEOUS EFFECTS OF INVENTION

According to the present invention, it is possible to provide a technique for removing a toxic substance in a gas by thermal excitation of an oxide semiconductor, which is a practically useful technique for decomposing and removing a toxic substance with high decomposition/removal efficiency.

### BRIEF DESCRIPTION OF DRAWINGS

FIG. 1 shows a schematic diagram of an apparatus for evaluating decomposition activity of a carried catalyst.

FIG. 2 shows a graph of decomposition characteristics of toluene when titanium oxide is used in a fluidized bed test.

FIG. 3 shows a graph of decomposition characteristics of toluene when chromium oxide is used in the fluidized bed test.

FIG. 4 shows a graph of decomposition characteristics of toluene when titanium oxide is used in a test of a cartridge type.

FIG. 5 shows a graph of decomposition characteristics of toluene when chromium oxide is used in the test of a cartridge type.

FIG. 6 shows a graph of decomposition characteristics of toluene by a catalyst element having nickel oxide carried by a cordierite honeycomb.

### BEST MODE FOR CARRYING OUT INVENTION

The system for decomposing and removing a toxic substance of the present invention is a system for decomposing and removing a toxic substance by introducing a gas containing the toxic substance into a reaction apparatus and causing the gas to contact with a heated oxide semiconductor, wherein a porous material carrying, as the oxide semiconductor, at least one of chromium oxide or nickel oxide is placed in the reaction apparatus, and the system includes thermally exciting the at least one of chromium oxide or nickel oxide, and contacting the gas containing the toxic substance with the at least one of chromium oxide or nickel oxide which is thermally excited.

In the case where VOC in a gas is decomposed by thermal excitation of conventional titanium oxide particles with a practical level of decomposition system, toluene with a high concentration of, for example, 10,000 ppm can be decreased to about 200 ppm, by removal thereof. However, it was difficult to remove toluene to the concentration of 200 ppm or less.

In contrast, in the present invention, VOC (e.g. toluene) in the gas can be removed almost to a zero level by using chromium oxide or nickel oxide as an oxide semiconductor.

Further, the porous material carrying chromium oxide or nickel oxide, which is used in the present invention, also shows high decomposition activity in decomposing ammonia and in decomposing hydrogen sulfide.

Since chromium oxide or nickel oxide which is an oxide semiconductor is carried by the porous material, exchange of the oxide semiconductor becomes easy and excellent maintenance properties are provided. Further, a capability of treating the toxic substance can be adjusted by appropriately adjusting the surface area of the porous material and the amount of the oxide semiconductor to be carried.

In the present invention, the toxic substance is decomposed and removed from the gas containing the toxic substance. The toxic substance is not particularly limited as long as it is a compound which is oxidatively decomposable and harmful to organisms. Particularly, from the viewpoint of toxic substance removal efficiency, the toxic substance is preferably at least one selected from a volatile organic compound, ammonia, or hydrogen sulfide.

The gas containing the toxic substance may be a gas containing only the toxic substance or a gas containing the toxic substance and air. Particularly, from the viewpoint of the toxic substance removal efficiency, the gas containing the toxic substance and oxygen is preferable.

The volatile organic compound is not particularly limited as long as it is an organic compound which volatilizes into the air at ordinary temperature and ordinary pressure. Examples thereof include so-called very volatile organic compounds (VVOC) having a boiling point of less than 50° C. and so-called volatile organic compounds (VOC) having a boiling point of 50° C. or more and less than 260° C. Specific examples thereof include aliphatic hydrocarbons such as methane and ethane; halogenated hydrocarbons such as dichloromethane and trichloroethane; aromatic hydrocarbons such as toluene, benzene, and xylene; alcohols such as methanol and ethanol; aldehydes such as formaldehyde and acetaldehyde; ketones such as acetone and methyl ethyl ketone; and esters such as ethyl acetate.

As for chromium oxide and nickel oxide in the present invention, chromium oxide and nickel oxide which are usually used as catalysts may be used without particular limitation. For example, chromium oxide and nickel oxide which have a purity of 95% or more may be used. Although the particle diameter of chromium oxide and nickel oxide is not particularly limited, from the viewpoint of toxic substance removal efficiency, it is preferably 5 μm or less.

As chromium oxide and nickel oxide in the present invention, for example, chromium oxide commercially available as a common pigment, nickel oxide manufactured by Sumitomo Metal Mining Co., Ltd., and the like may be used.

The porous material in the present invention is not particularly limited as long as it can carry at least one of chromium oxide or nickel oxide and can be penetrated with gas containing the toxic substance. Particularly, a pseudo honeycomb body formed by stacking plural SUS meshes, a cordierite honeycomb, or a corrugated honeycomb made of glass fiber, silica, zeolite and/or the like is preferable from the viewpoint of the toxic substance removal efficiency.

The pseudo honeycomb body is not particularly limited as long as it is a honeycomb body in which plural SUS meshes are stacked. The SUS mesh is not particularly limited as long as it is configured into a mesh form with a stainless steel wire. For example, an SUS mesh having a wire diameter of from 50 to 500 μm and a wire interval of from 50 to 500 μm may be used.

The shape of the SUS mesh may be appropriately selected depending on the purpose and may be circular or rectangular.

The number of SUS meshes stacked is not particularly limited as long as it is two or more and it may be appropriately selected depending on the purpose.

The cordierite honeycomb and the corrugated honeycomb are not particularly limited as long as they have cordierite or a honeycomb structure containing glass fiber, silica, and zeolite. For example, generally commercially available honeycombs may be used.

Among them, a honeycomb structure with from 50 to 600 cells per square inch is preferable from the viewpoint of the toxic substance decomposition efficiency.

In the present invention, the method for allowing chromium oxide and nickel oxide to be carried by the porous material is not particularly limited and it may be appropriately selected according to the porous material.

For example, when the pseudo honeycomb body in which plural SUS meshes are stacked is used as the porous material, chromium oxide and nickel oxide can be carried by the SUS mesh in the following manner.

A commercially available SUS mesh is punched into a shape selected, if necessary, and an oxide film of chromium oxide (for example, thickness: about 1 μm) is formed on the SUS surface with a wet hydrogen oxidation device.

Subsequently, chromium oxide or nickel oxide (oxide semiconductor particles) is carried by the SUS mesh by electrophoresis electrodeposition method which is a technique similar to electroplating. That is, oxide semiconductor particles are dispersed in the electrodeposition liquid and these oxide semiconductor particles are electrodeposited on the SUS mesh (for example, film thickness: about 3 μm) by using the SUS mesh as an anode and an A1 sheet electrode as a cathode and applying, for example, a direct voltage of 100V.

The electrodeposition liquid is not particularly limited as long as chromium oxide or nickel oxide is dispersed in a conductive medium and commonly used electrodeposition liquid may be used. For example, electrodeposition liquid which is configured to include a material to be carried, an organic solvent, a dispersant may be used. More specifically, it may have the same configuration as the suspension to be described below.

The time to apply direct voltage may be appropriately selected depending on the purpose. For example, it may be set to a range of 0.1 to 10 seconds.

Chromium oxide and nickel oxide particles are more firmly carried by the SUS mesh by forming an oxide film of chromium oxide on the SUS surface. In spite of repeated thermal hysteresis (for example, room temperature and 500° C.), they are firmly carried. This is considered because, for example, the oxide film of chromium oxide acts as a buffer layer to relieve a difference in expansion coefficient among the SUS mesh and chromium oxide and nickel oxide particles.

When the cordierite honeycomb or the corrugated honeycomb made of glass fiber, silica, zeolite and/or the like is used as the porous material, chromium oxide and nickel oxide can be carried by the cordierite honeycomb or the corrugated honeycomb made of glass fiber, silica, zeolite and/or the like, for example, in the following manner.

A suspension containing nitrocellulose and at least one of chromium oxide particles or nickel oxide particles are prepared and the cordierite honeycomb (2MgO.Al₂O₃.5SiO₂: for example, manufactured by KYOCERA Corporation: 200 cpi (cell per square inch)) is immersed in the prepared liquid, followed by heat treatment at from 180° C. to 250° C., thereby allowing chromium oxide and nickel oxide to be carried.

The medium in the suspension is not particularly limited as long as it is a solvent capable of dissolving nitrocellulose. Usable examples thereof include alcohols such as ethanol and isopropanol; ketones such as acetone; and esters such as ethyl acetate. Among them, esters and ketones are preferable.

The content of nitrocellulose in the suspension is not particularly limited and it may be appropriately selected depending on the content of the oxide semiconductor. For example, it may be set to a range of from 0.1 to 2% by weight.

The content of the oxide semiconductor in the suspension is not particularly limited and it may be appropriately selected depending on the amount of the oxide semiconductor to be carried by the porous material. For example, it may be set to a range of from 1 to 10% by weight.

The immersion time may be appropriately selected depending on the amount of the oxide semiconductor to be carried by the porous material. For example, it may be set to a range of from several seconds to 1 minute.

The heat treatment is performed at 180° C. or more, and is preferably performed at a range of from 180 to 250° C. The time of heat treatment is not limited as long as nitrocellulose contained in the suspension is removed. For example, the time of heat treatment may be set to a range of from 30 minutes to 2 hours.

When the oxide semiconductor is carried by the cordierite honeycomb or the corrugated honeycomb made of glass fiber, silica, zeolite and/or the like by the method, the oxide semiconductor (chromium oxide and nickel oxide) is firmly carried by the cordierite honeycomb or the corrugated honeycomb made of glass fiber, silica, zeolite and/or the like. Further, chromium oxide and nickel oxide are uniformly carried by the outer wall of the cordierite honeycomb or the corrugated honeycomb made of glass fiber, silica, zeolite and/or the like, and, even if the thermal hysteresis of room temperature and 500° C. is repeated, cracks and peeling are not caused.

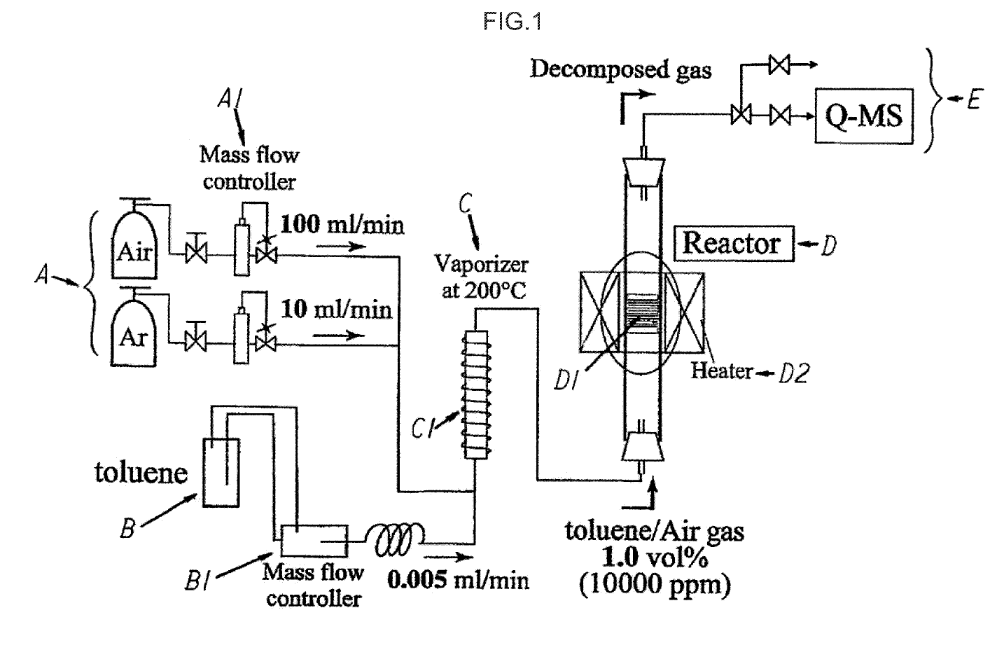

As a means for evaluating the toxic substance decomposition/removal activity, for example, a system as outlined in in FIG. 1 is employed. The same configuration may be adopted for the system for removing a toxic substance of the present invention.

That is, the system includes a carrier gas supplying means A, a VOC filling means B, a VOC gasification means C, a reaction means D, and a decomposed gas recovery means E. The carrier gas supplying means A and the VOC filling means B are provided with flow control means A1 and B1. Further, the VOC gasification means C includes a gas heating means C1.

At the heart of the reaction means D, a cartridge-type unit D1, in which a porous material carrying chromium oxide or nickel oxide therein is disposed so as to face a gas flow, is disposed. It is preferable that the unit D1 is detachably disposed. The unit D1 is surrounded by a heating means D2 for heating to a desired temperature. Chromium oxide or nickel oxide is thermally excited by the heating means D2 and a toxic substance is contacted with the excited chromium oxide or nickel oxide.

The cartridge-type unit D1 is a porous material carrying chromium oxide or nickel oxide, preferably a stacked product of SUS meshes, or a cordierite honeycomb or a corrugated honeycomb made of glass fiber, silica, zeolite and/or the like. The stacked product of SUS meshes is produced by stacking SUS meshes carrying chromium oxide or nickel oxide and is, for example, vertically arranged in a cartridge. It can be said to be a pseudo honeycomb-type catalytic element with a high degree of freedom that allows for free selection of the interval of the SUS mesh and the number of sheets of the SUS mesh.

As described above, when toluene is decomposed by thermal excitation of titanium oxide particles, toluene of a high concentration of 10000 ppm can be removed to a concentration of 200 ppm; however, it was difficult to remove toluene to the concentration of 200 ppm or less. On the other hand, decomposition of toluene can be removed almost to a zero level by using at least one of chromium oxide particles or nickel oxide. Further, chromium oxide or nickel oxide can be firmly carried by a cordierite honeycomb which is a typical example of the porous material as compared with titanium oxide.

### EXAMPLES

Hereinafter, the present invention is specifically described with reference to examples, however, the present invention is not limited to these examples. Unless otherwise noted, “%” is based on mass.

<Carrying of Oxide Semiconductor by SUS Mesh>

An oxide semiconductor was carried by an SUS mesh in the following manner.

A commercially available SUS mesh (wire diameter: 100 μm, wire interval: 250 μm) was punched into a 26-mm disk and an oxide film of chromium oxide (thickness: about 1 μm) was formed on the SUS surface with a wet hydrogen oxidation device.

Then, chromium oxide or nickel oxide (catalyst particles and oxide semiconductor particles) were carried by the SUS mesh by the electrophoresis electrodeposition method, i.e., a technique similar to electroplating. That is, the catalyst particles were dispersed in electrodeposition liquid (composition: 100 ml of acetone, 0.5 g of nitrocellulose) so as to have a content of 5%. These oxide semiconductor particles were electrodeposoted on the SUS mesh (film thickness: about 3 μm) by using the SUS mesh as an anode and an A1 sheet electrode as a cathode and applying a direct voltage of 100 V for 0.50.5 seconds.

<Carrying of Oxide Semiconductor by Cordierite Honeycomb>

An oxide semiconductor was carried by a cordierite honeycomb in the following manner.

A suspension containing ethyl acetate as a solvent, 0.5% of nitrocellulose, 5% of chromium oxide particles (manufactured by LANXESS) or nickel oxide particles (Sumitomo Metal Mining Co., Ltd.) was prepared. The cordierite honeycomb (2MgO.Al₂O₃.5SiO₂: manufactured by KYOCERA Corporation: C600, 200 cpi (cell per square inch)) was immersed in the suspension for 10 seconds.

Then, the immersed honeycomb was heat-treated at 180° C. for 1 hour and the oxide semiconductor was carried by the cordierite honeycomb.

### Reference Example

### Fluidized Bed Test

20 ml of titanium oxide (ST01: ISHIHARA SANGYO KAISHA, LTD.) was placed in a 250-ml pressure reactor to form a fluidized bed. Similarly, in place of titanium oxide, an equivalent amount of chromium oxide (Wako Pure Chemical Industries, Ltd.) was placed therein. 14000 ppm of toluene was introduced from the lower part of the pressure reactor using air as a carrier gas. The decomposition test was performed at a flow rate of 300 ml/min.

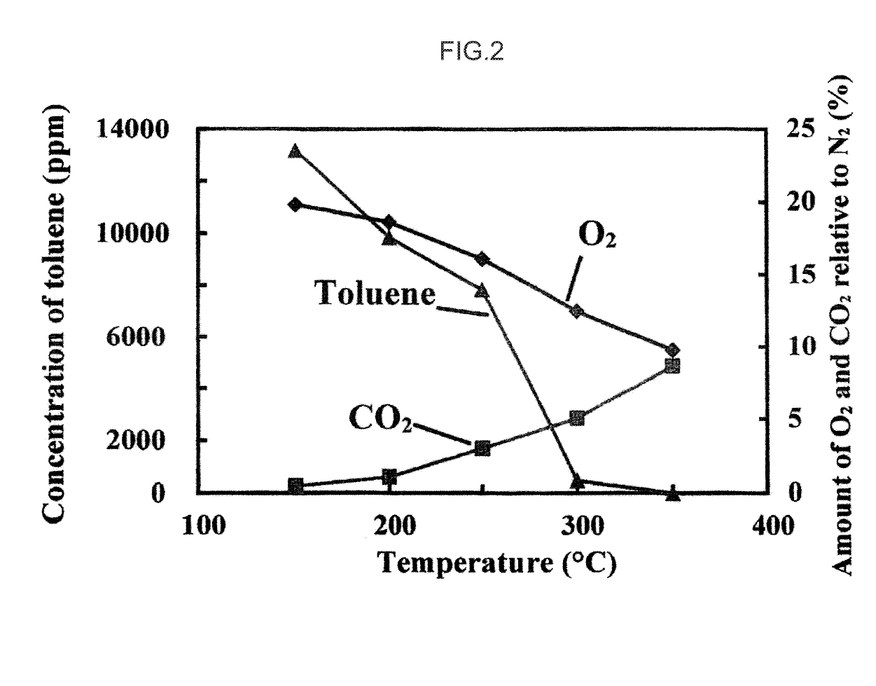

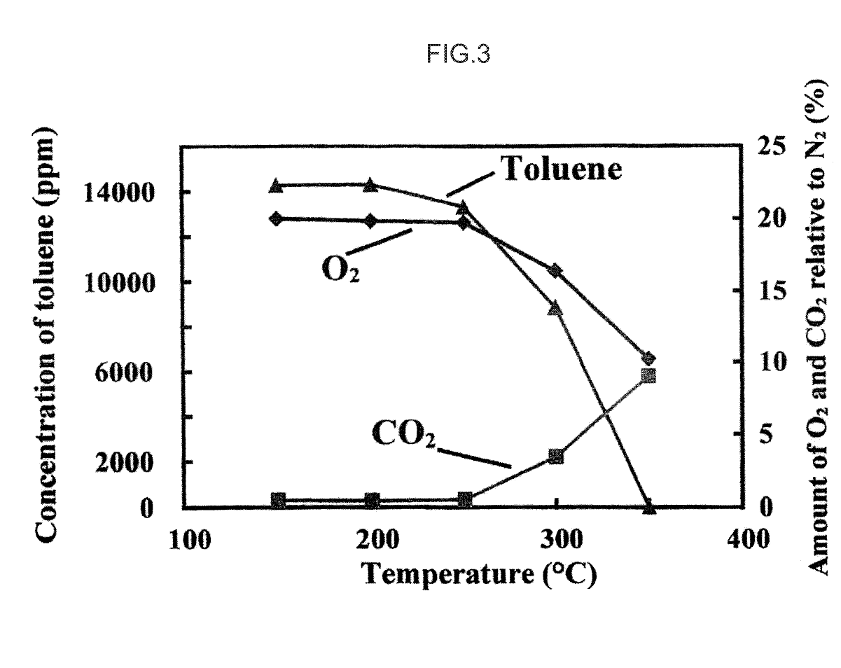

FIGS. 2 and 3 show graphs of decomposition characteristics (a relationship between decomposition temperature and decomposition) of toluene by titanium oxide and chromium oxide, respectively. As for the decomposition by titanium oxide in FIG. 2, oxygen is consumed at the same time as the decomposition of toluene and carbon dioxide gas is increased. In this system, the decomposition of toluene is rapidly proceeded at around 150° C., however, the decomposition is weak at 300° C. and perfect decomposition is not conducted immediately. Thereafter, toluene is fully decomposed at 350° C.

On the other hand, in the system (FIG. 3) of chromium oxide, the decomposition starting temperature of toluene is slightly high, the decomposition is quickly progressed, and toluene is decomposed to a zero level at 350° C. This shows an advantage in the perfect decomposition by chromium oxide.

### Example 1

### Test Using Cartridge Type

The decomposition test was performed with the decomposition system using the cartridge-type catalyst element, which is outlined in FIG. 1. The used cartridge-type catalyst element was a cartridge-type catalyst element including therein a porous material formed by stacking fifteen sheets of the SUS meshes carrying oxide semiconductor carried obtained as above.

10000 ppm of toluene was introduced using air as a carrier gas. The decomposition test was performed at a flow rate of 100 ml/min.

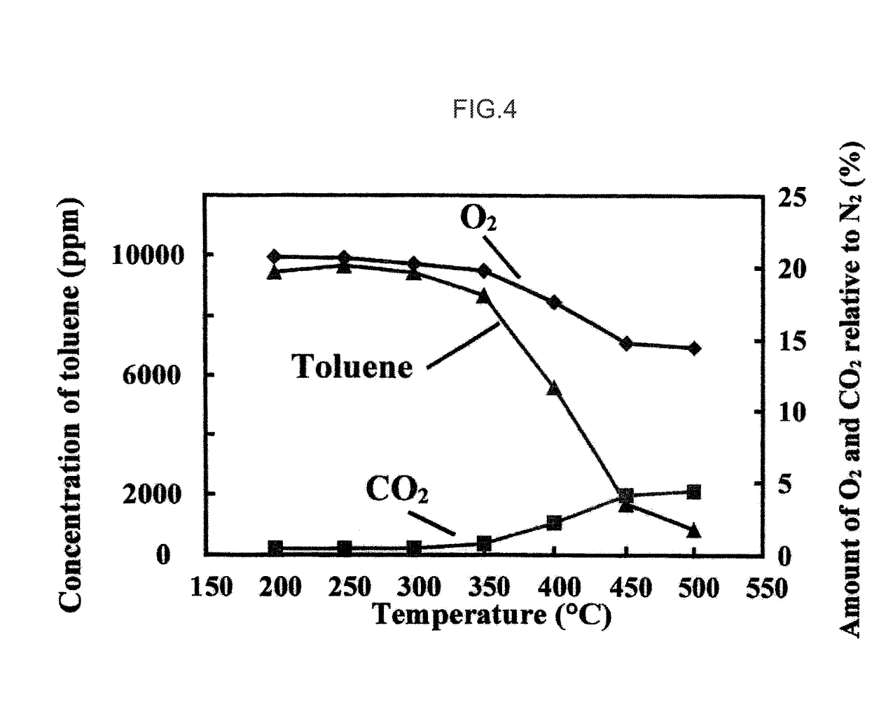

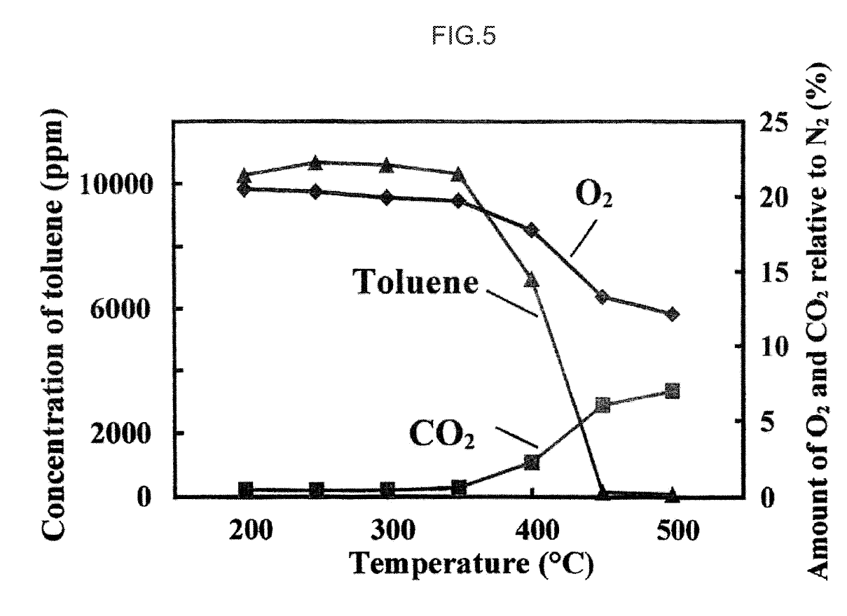

FIG. 4 shows a graph of decomposition characteristics by titanium oxide and FIG. 5 shows a graph of decomposition characteristics by chromium oxide. In both cases, the decomposition starting temperature is higher by about 100° C. than the case of the fluidized bed.

In the case of titanium oxide, the perfect decomposition of toluene is not achieved even at around 450° C. and is poor similarly to the case of the fluidized bed (FIG. 2). On the other hand, in the case of chromium oxide (FIG. 5), the decomposition is quickly progressed and toluene is fully decomposed at 450° C. This shows an advantage in the perfect decomposition by chromium oxide.

### Example 2

### Test Using Cordierite Honeycomb

The decomposition test was performed with the decomposition system outlined in FIG. 1. In place of the cartridge-type catalyst element in Example 1, the cordierite honeycomb carrying nickel oxide obtained as above was used as a catalyst element.

10000 ppm of toluene was introduced using air as a carrier gas. The decomposition test was performed at a flow rate of 100 ml/min.

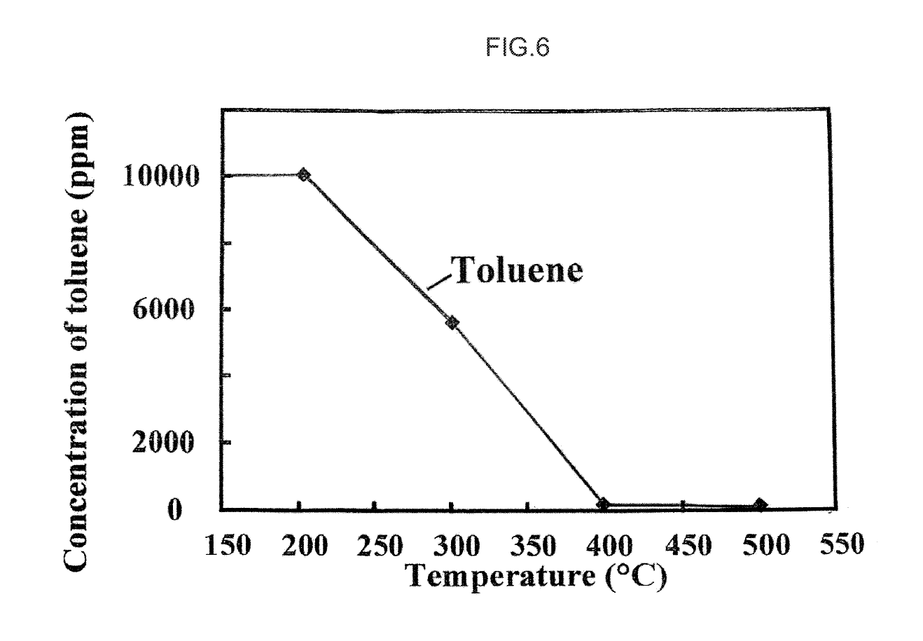

FIG. 6 shows a graph of decomposition characteristics of toluene by nickel oxide. It is apparent that the decomposition of toluene is started at around 200° C. and the decomposition is fully progressed to a zero level at 400° C.

### Example 3

### Decomposition Test of Ammonia and Hydrogen Sulfide

As described above, nickel oxide, chromium oxide, and, for comparison, titanium oxide were respectively carried by a cordierite honeycomb (2MgO.Al₂O₃.5SiO₂: KYOCERA Corporation: C600, 200 cpi).

200 ppm of ammonia was introduced into each of the carried catalysts using air as a carrier gas. The decomposition test was performed under conditions: 360° C., SV (space velocity: a value obtained by dividing a volume of the gas processed per hour by a volume of the catalyst and its dimension is h⁻¹.) of 30000.

The decomposition test was performed in the same manner as described above except that 130 ppm of hydrogen sulfide was used in place of 200 ppm of ammonia.

As a result, in the case of nickel oxide, high decomposition rates were achieved and the decomposition rate of ammonia and that of hydrogen sulfide were 89% and 48%, respectively. In the case of chromium oxide, high decomposition rates were achieved and the decomposition rate of ammonia and that of hydrogen sulfide were 79% and 46%, respectively.

On the other hand, in the case of titanium oxide, high decomposition activity (84%) was in decomposing ammonia, however, the decomposition rate of hydrogen sulfide was only 14%.

### INDUSTRIAL APPLICABILITY

The present invention is described as above. It is found that the VOC can be fully decomposed almost to a zero level by using a chromium oxide or nickel oxide catalyst, that high decomposition activity is exhibited in decomposing ammonia and in decomposing hydrogen sulfide, that chromium oxide and nickel oxide can be firmly carried by a cordierite honeycomb as compared with titanium oxide, and that although chromium oxide and nickel oxide each have a specific surface area of only from about 1 to 3 m²/g, they have an oxidizing power equal to titanium oxide having a specific surface area of about 300 m²/g. Therefore, the present invention can be largely contributed to the removal of the toxic substance in the gas.

### DESCRIPTION OF REFERENCE SIGNS

A Carrier gas supplying means
A1 Flow control means
B VOC filling means
B1 Flow control means
C VOC gasification means
C1 Gas heating means
D Reaction means
D1 Cartridge-type unit (or honeycomb-type unit)
D2 Heating means
E Decomposed gas recovery means

1. A system for decomposing and removing a toxic substance by introducing a gas containing the toxic substance into a reaction apparatus and causing the gas to contact with a heated oxide semiconductor, wherein a porous material carrying, as the oxide semiconductor, at least one of chromium oxide or nickel oxide is placed in the reaction apparatus, and the system is configured to thermally excite the at least one of chromium oxide or nickel oxide, and contact the gas containing the toxic substance with the at least one of chromium oxide or nickel oxide which is thermally excited.

2. The system for decomposing and removing a toxic substance according to claim 1, wherein the toxic substance is at least one selected from a volatile organic compound, ammonia, or hydrogen sulfide, and the gas is air.

3. The system for decomposing and removing a toxic substance according to claim 1, wherein the porous material is a pseudo honeycomb body formed by stacking a plurality of SUS meshes.

4. The system for decomposing and removing a toxic substance according to claim 1, wherein the porous material is a cordierite honeycomb or a corrugated honeycomb.

5. The system for decomposing and removing a toxic substance according to claim 1, wherein the porous material carrying the at least one of chromium oxide or nickel oxide is obtained by immersing the porous material in a suspension containing at least one of chromium oxide particles or nickel oxide particles and nitrocellulose and then heat-treated at 180° C. or higher to allow the porous material to carry the at least one of chromium oxide particles or nickel oxide particles.
